(19) United States
(12) Patent Application Publication
(10) Pub. No.: US 2020/0079690 A1
(43) Pub. Date: Mar. 12, 2020

(54) Metal-Coated Glass Fiber, Metal-Coated Glass Fiber Strand, Method for Manufacturing Metal-Coated Glass Fiber, and Method for Manufacturing Metal-Coated Glass Fiber Strand

(71) Applicant: Central Glass Company, Limited, Ube-shi, Yamaguchi (JP)

(72) Inventors: Yuya ASAKAWA, Matsusaka-shi, Mie (JP); Masanori SAITO, Matsusaka-shi, Mie (JP)

(21) Appl. No.: 16/603,883

(22) PCT Filed: Mar. 23, 2018
(86) PCT No.: PCT/JP2018/011791

§ 371 Date: Oct. 9, 2019

(30) Foreign Application Priority Data
Apr. 13, 2017 (JP) 2017-079475
Nov. 29, 2017 (JP) 2017-229470

(51) Int. Cl. C03C 25/46; C23C 2/00; C03C 13/00

(52) U.S. Cl. CPC C03C 25/46; C23C 2/003; C03C 13/00; C03C 2218/13; C03C 2217/268; C03C 2217/258; C03C 2217/252

(57) ABSTRACT

A manufacturing method of a metal-coated glass fiber according to the present invention includes: drawing a glass fiber from a bushing nozzle of a glass melting furnace; discharging, from an orifice of a metal melting furnace in which a metal for forming a metal coating layer is melted, a molten metal in a dome shape or substantially spherical shape; and bringing the glass fiber into contact with the molten metal, wherein the metal melting furnace has on a wall surface thereof two orifices to discharge two droplets of the molten metal such that end portions of the two droplets abut or overlap each other to define a recess therebetween, and wherein the metal coating layer is formed on the glass fiber by passing the glass fiber downward through the recess and bringing the glass fiber into contact with both of the two droplets.

### FIELD OF THE INVENTION

The present invention relates to a metal-coated glass fiber and a method for manufacturing a metal-coated glass fiber.

### BACKGROUND ART

Metal-coated glass fibers, each of which has a surface partially or entirely covered with a coating of metal, have been proposed for use as electromagnetic-shielding conductive fillers and the like. Although hot dipping, electroless plating, vapor deposition, sputtering and the like are known as methods for applying metal coatings to glass fibers, there have been proposed many metal coating methods using hot dipping which offers a good balance between production capacity and manufacturing cost. Patent Publications 1 to 7 each disclose a method for manufacturing a metal-coated glass fiber by bringing a molten metal into contact with a glass fiber under drawing.

### PRIOR ART DOCUMENTS

### Patent Publications

Patent Publication 1: U.S. Pat. No. 2,980,956
Patent Publication 2: Japanese Examined Patent Application Publication No. S36-2580
Patent Publication 3: Japanese Unexamined Patent Application Publication No. S61-58843
Patent Publication 4: Japanese Unexamined Patent Application Publication No. S63-2838
Patent Publication 5: Japanese Utility Modal Application Publication No. S61-50737
Patent Publication 6: Japanese Unexamined Patent Application Publication No. H01-252555

### Patent Publication 7: Japanese Unexamined Patent Application Publication No. 2017-14090

### SUMMARY OF THE INVENTION

In order to effectively produce a glass fiber filler, it is generally preferred to gather glass fibers into a strand and cut the glass fiber strand. Even in the case of metal-coated glass fibers, it is preferred to gather the metal-coated glass fibers into a strand for efficient production of a glass fiber filler. However, the metal-coated glass fibers are easier to curl than ordinary glass fibers so that it is difficult to gather the metal-coated glass fibers into a strand. The cause of curing of the metal-coated glass fiber is due to a large difference in thermal expansion coefficient between the metal coating layer and the glass fiber.

As disclosed in Patent Publications 1 to 7, the metal-coated glass fiber is obtained by applying a molten metal to a glass fiber and thereby forming a coating layer of metal on the glass fiber. Consequently, both of the metal coating layer and the glass fiber undergo volume shrinkage during the cooling of the glass fiber after the application of the metal coating. A surface portion of the glass fiber is influenced by not only the volume shrinkage of the glass fiber itself but also the volume shrinkage of the metal coating layer. There is a small influence or no influence exerted by the volume shrinkage on the areas of the glass fiber on which the metal coating layer is thin or on which the metal coating layer is not formed. Consequently, the glass fiber is deformed in shape when the thickness of the metal coating layer is not uniform in the circumferential direction of the glass fiber. The metal-coated glass fiber is thus easily curled.

In Patent Publications 2 to 4, for example, the metal coating layer is formed on the glass fiber by bringing the molten metal into contact with the glass fiber in one direction. In this method, the thickness of the metal coating layer tends to be nonuniform in the circumferential direction of the glass fiber. In some cases, the metal coating may not be applied to a part of the glass fiber. In Patent Publication 1, the metal coating layer is formed on the glass fiber by discharging the molten metal from opposite directions to form a molten metal pool with both vertical sides thereof unsupported, and vertically passing the glass fiber through the molten metal pool. In this method, it is unlikely that there will occur a part of the glass fiber to which the metal coating is not applied. On the other hand, it becomes necessary to control the viscosity of the molten metal pool, that is, control the temperature of the molten metal pool precisely in order to stably maintain the molten metal pool with both vertical sides thereof unsupported. For these reasons, it has been difficult to make the thickness of the metal coating layer uniform in the circumferential direction of the glass fiber.

The present invention has been made in view of the above circumstances. It is an object of the present invention to provide a method for efficiently manufacturing a metal-coated glass fiber and metal-coated glass fiber strand, in which a coating layer of metal is uniform in thickness in a circumferential direction of the glass fiber. It is also an object of the present invention to provide a metal-coated glass fiber strand suitable for use as a filler.

### Means for Solving the Problems

The present inventors have made extensive researches on the method for manufacturing a metal-coated glass fiber by: drawing a glass fiber from a bushing nozzle of a glass melting furnace; discharging, from an orifice of a metal melting furnace in which a metal for forming a metal coating layer is molten, a molten metal in a dome shape or substantially spherical shape; and bringing the drawn glass fiber into contact with the discharged molten metal. As a result of those researches, the present inventors have found that it is possible to efficiently obtain a metal-coated glass fiber and metal-coated glass fiber strand, in which the metal coating is uniform in thickness in the circumferential direction of the glass fiber, by bringing the glass fiber into contact with the molten metal at a plurality of points in the circumferential direction of the glass fiber.

Accordingly, a first aspect of the present invention is a manufacturing method of a metal-coated glass fiber, comprising: drawing a glass fiber; and discharging a molten metal from a metal melting furnace, wherein the metal melting furnace has on a wall surface thereof two orifices to discharge two droplets of the molten metal such that end portions of the two droplets abut or overlap each other to define a recess therebetween, and wherein a coating layer of the metal is formed on the glass fiber by passing the glass fiber downward through the recess and bringing the glass fiber into contact with both of the two droplets.

The composite molten metal droplet, formed by combination of the two first and second molten metal droplets, does not have a simple droplet shape but has a shape in which the recess is defined at the joint between the first and second molten metal droplets. The glass fiber is brought into contact with both of the first and second molten metal droplets through the recess (also sometimes referred to as “recess point”) whereby the molten metal is substantially uniformly applied to the entire glass fiber.

A second aspect of the present invention is a metal-coated glass fiber, comprising: a glass fiber; and a metal coating layer formed on an entire circumference of the glass fiber, wherein the metal coating layer satisfies the following conditions: T=(Tmax+Tmin)/2, V={(Tmax−Tmin)/T}×100, 0.2 μm≤T≤10 μm and V≤100% where Tmax (μm) is a maximum thickness of the metal coating layer; Tmin (μm) is a minimum thickness of the metal coating layer; and T (μm) is an average thickness of the metal coating layer; and V (%) is a thickness unevenness of the metal coating layer.

A third aspect of the present invention is a manufacturing method of a metal-coated glass fiber strand, comprising: providing two or more pieces of the glass fiber coated with the molten metal by the above metal-coated glass fiber manufacturing method; and producing the metal-coated glass fiber strand by gathering together the two or more pieces of the glass fiber coated with the molten metal.

A fourth aspect of the present invention is a metal-coated glass fiber strand, comprising gathering two or more pieces of the above metal-coated glass fiber together along a length direction thereof.

### Effects of the Invention

The metal-coated glass fiber according to the present invention has small variations in the thickness of the metal coating layer when viewed in cross section. Since there hardly occurs shrinkage of the metal-coated glass fiber, the metal-coated glass fiber strand can be produced by gathering a plurality of pieces of the metal-coated glass fiber together with a sizing agent etc. Further, the metal-coated glass fiber manufacturing method according to the present invention enables formation of the uniform metal coating layer by application of the molten metal at a plurality of points to the glass fiber under drawing when viewed in cross section.

### BRIEF DESCRIPTION OF THE DRAWINGS

FIG. 1 is an enlarged view of region A of FIG. 4, showing a first embodiment of the present invention, in which FIG. 1(a) is a front view; FIG. 1(b) is a cross-sectional view as taken along line I-I of the front view; and FIG. 1(c) is a perspective view.

FIG. 2 is an enlarged view of region A of FIG. 4, showing a second embodiment of the present invention, in which FIG. 2(a) is a front view; FIG. 2(b) is a cross-sectional view as taken along line II-II of the front view; and FIG. 2(c) is a perspective view.

FIG. 3 is an enlarged view of region A of FIG. 4, showing a third embodiment of the present invention, in which FIG. 3(a) is a front view; FIG. 3(b) is a cross-sectional view as taken along line of the front view; and FIG. 3(c) is a perspective view.

FIG. 4 is a schematic view showing one example of a device for manufacturing a metal-coated glass fiber strand according to the present invention, in which FIG. 4(a) is a side view; and FIG. 4(b) is a front view of FIG. 4(a).

FIG. 5 is an enlarged view of region A of FIG. 4, schematically showing the first embodiment, in which FIG. 5(a) is a front view; and FIG. 5(b) is a cross-sectional view as taken along line IV-IV of the front view.

FIG. 6 is an enlarged view of region A of FIG. 4, schematically showing the second embodiment, in which FIG. 6(a) is a front view; and FIG. 6(b) is a cross-sectional view as taken along line V-V of the front view.

FIG. 7 is an enlarged view of region A of FIG. 4, schematically showing the third embodiment, in which FIG. 7(a) is a front view; and FIG. 7(b) is a cross-sectional view as taken along line VI-VI of the front view.

FIGS. 8(a), 8(b) and 8(c) are perspective views showing examples of metal-coated glass fibers, in which FIG. 8(a) is a perspective view of a metal-coated glass fiber according to the present invention.

FIG. 9 is a schematic view showing a state where surfaces of molten metal droplets respectively discharged from two orifices contact each other at one point without allowing a flow of molten metal between the molten metal droplets.

FIG. 10 is a schematic view showing a state where contours of surfaces of molten metal droplets respectively discharged from two orifices intersect to provide an overlap between the molten metal droplets while allowing a flow of molten metal between the molten metal droplets.

### DETAILED DESCRIPTION OF THE EMBODIMENTS

Hereinafter, embodiments of the present invention will be described below with reference to the drawings.

1. Metal-Coated Glass Fiber 1 and Metal-Coated Glass Fiber Strand 11

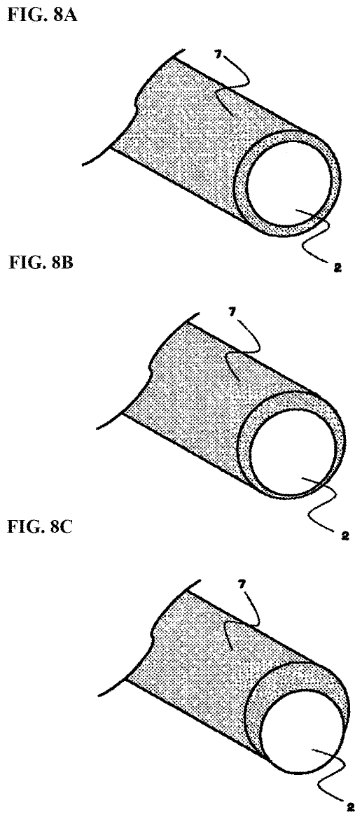

FIG. 8 is a schematic view of a metal-coated glass fiber 1 according to one embodiment of the present invention. The metal-coated glass fiber 1 includes a glass fiber 2 and a metal coating layer 7 formed on the glass fiber 2 along a longitudinal direction of the glass fiber 2. It is conceivable to form the metal coating layer 7 to the entire surface of the glass fiber 2 in the longitudinal direction as shown in FIGS. 8(a) and 8(b). Alternatively, it is conceivable to form the metal coating layer 7 on a part of the surface of the glass fiber 2 in the longitudinal direction as shown in FIG. 8(c). In the case where the metal coating layer 7 is formed on the entire surface of the glass fiber 2 in the longitudinal direction, the thickness of the metal coating layer 7 may be uniform throughout the entire surface as shown in FIG. 8(a) or may not be uniform as shown in FIG. 8(b). Herein, the term “longitudinal direction” corresponds to a direction along which the glass fiber 2 is drawn from a glass melting furnace 3.

The metal-coated glass fiber 1 of FIG. 8(a) is uniform in thickness and thus is difficult to curl, whereby two or more pieces of this metal-coated glass fiber 1 can suitably be gathered together into a metal-coated glass fiber strand 11. The metal-coated glass fiber 1 according to the present invention is of the type shown in FIG. 8(a). The metal-coated glass fiber strand 11 according to the present invention is of the type obtained by gathering two or more pieces of the metal-coated glass fiber 1 of FIG. 8(a), more specifically, 2 to about 20000 pieces of the metal-coated glass fiber 1 of FIG. 8(a). The metal-coated glass fiber strand 11 can be used as an electromagnetic-shielding conductive filler by being impregnated into a resin.

<Metal Coating Layer 7>

There is no particular limitation on the metal used for formation of the metal coating layer 7 in the present invention as long as the metal has conductivity. It is preferable that the metal contains at least one selected from the group consisting of zinc, aluminum, tin, indium and titanium for good conductivity. It is more preferable that the metal contains zinc for excellent conductivity. Aluminum and titanium are difficult to oxidize during the hot dipping in the air atmosphere and thus can be used solely or in the form of an alloy thereof with zinc. In the case of using the alloy of aluminum and/or titanium with zinc, the total content of aluminum and titanium in the alloy is preferably in the range of 0.01 to 30 mass %.

The metal coating layer 7 may contain 30 mass % or less in total of any arbitrary metal component other than the above metals based on the total amount of the metal coating layer 7. Examples of the arbitrary metal component are barium, strontium, calcium, magnesium, beryllium, zirconium, manganese and tantalum. Among other, magnesium, beryllium, zirconium, manganese and tantalum are difficult to oxidize during the hot dipping in the air atmosphere and thus are suitably usable as the arbitrary metal component. There is no particular limitation on the lower limit of the content of the additional metal component. In regard to the lower limit, the content of the additional metal component may be set to e.g. 0.01 mass % or more, preferably 0.03 mass % or more, or 0.05 mass % or more. In regard to the upper limit, the content of the additional metal component may preferably be set to 20 mass % or less, 10 mass % or less, 5 mass % or less, 4 mass % or less, 3 mass % or less, or 1 mass % or less. The metal coating layer 7 may contain, in addition to the above arbitrary metal component, an impurity component derived from the raw material or inevitably entering during the manufacturing process.

As to the volume ratio of the glass fiber 2 and the metal coating layer 7, it is preferable that the metal-coated glass fiber 1 includes 5 to 95 vol % of the glass fiber 2 and 5 to 95 vol % of the metal coating layer 7 in the present invention. The diameter of the glass fiber 2 becomes small, which can result in a deterioration of productivity during the manufacturing process, when the volume percentage of the glass fiber 2 is lower than 5 vol %. When the volume percentage of the glass fiber 2 is higher than 95 vol %, it becomes difficult to form the metal coating layer 7. In view of these, the volume percentage of the glass fiber 2 is preferably 5 to 95 vol % (that is, the volume percentage of the metal coating layer 7 is 5 to 95 vol %). More preferably, the volume percentage of the glass fiber 2 is 10 to 95 vol % (that is, the volume percentage of the metal coating layer 7 is 5 to 90 vol %). Still more preferably, the volume percentage of the glass fiber 2 is 20 to 95 vol % (that is, the volume percentage of the metal coating layer 7 is 5 to 80 vol %). Alternatively, the volume percentage of the glass fiber 2 may be 10 to 90 vol % (that is, the volume percentage of the metal coating layer 7 is 10 to 90 vol %). The volume percentage of the glass fiber 2 may be 20 to 90 vol % (that is, the volume percentage of the metal coating layer 7 is 10 to 80 vol %).

In the present invention, the metal-coated glass fiber 1 has a structure in which the coating layer of metal is formed on the entire circumference of the glass fiber 2. The average thickness (T: μm) and thickness unevenness (V: %) of the metal coating layer 7 of the metal-coated glass fiber 1 are given by the following equations (I) and (II) using the maximum thickness (Tmax: μm) of the metal coating layer 7 and the minimum thickness (Tmin: μm) of the metal coating layer 7. On the circumference of the glass fiber 2, the amount of a molten metal applied to the glass fiber 2 is uniform. The applied molten metal is spread on the glass fiber 2 during the time for solidification of the molten metal. Consequently, the metal coating layer 7 attains a continuous thickness. The metal coating layer 7 becomes maximum in thickness at a position where the molten metal is applied on the circumference of the glass fiber 2 and becomes minimum in thickness at a position corresponding to the end of the spread molten metal. The average thickness of the metal coating layer 7 is thus equal to a mean thickness value the metal coating layer 7. For this reason, the average thickness of the metal coating layer 7 can be determined by dividing the sum of the maximum thickness Tmax and minimum thickness Tmin of the metal coating layer 7 by 2. Further, the thickness unevenness of the metal coating layer 7 can be determined by dividing the difference between the maximum thickness Tmax and minimum thickness Tmin of the metal coating layer 7 by the average thickness of the metal coating layer 7.

T=(T max+T min)/2 (I)

V={(T max−T min)/T}×100 (II)

The average thickness (T: μm) of the metal coating layer 7 of the metal-coated glass fiber 1 is preferably 0.2 to 10 μm in the present invention. When the average thickness of the metal coating layer 7 is smaller than 0.2 μm, it becomes difficult to form the metal coating layer 7. When the average thickness of the metal coating layer 7 is larger than 10 μm, the amount of the molten metal fed from orifices tends to be insufficient due to increase in the amount of the molten metal applied to the glass fiber 2 so that there likely to occur large variations in the average thickness of the metal coating layer 7. The average thickness of the metal coating layer 7 is more preferably in the range of 0.2 μm to 9 μm, still more preferably 0.2 μm to 8 μm.

The thickness unevenness (V: %) of the metal coating layer 7 of the metal-coated glass fiber 1 is preferably 100% or less in the present invention. When the thickness unevenness of the metal coating layer 7 is more than 100%, the metal-coated glass fiber 1 becomes easier to curl due to the occurrence of anisotropic shrinkage on the circumference of the fiber. The thickness unevenness of the metal coating layer 7 is thus preferably 100% or less, more preferably 80% or less, still more preferably 60% or less. It is considered that variations in the thickness of the metal coating layer 7 decrease with decrease in the thickness unevenness of the metal coating layer 7.

<Glass Fiber 2>

Preferably, the glass fiber 2 has a diameter of 1 to 100 μm. When the diameter of the glass fiber 2 is smaller than 1 μm, the glass fiber 2 becomes easy to break. The occurrence of such fiber breakage leads to a deterioration of productivity during the manufacturing process. When the diameter of the glass fiber 2 is larger than 100 μm, the area of the glass fiber 2 per unit weight becomes small so that it is difficult to achieve desired performance due to decrease in the metal coverage area of the fiber material. In view of the above lower and upper limit factors, the diameter of the glass fiber 2 may be set to 2 to 50 μm, 2 to 30 μm, or 3 to 20 μm.

Examples of the composition of the glass fiber 2 are those of E glass, C glass, S glass, D glass, ECR glass, A glass, AR glass and the like. Among others, the composition of E glass is preferred. The E glass is less in alkali content and thus is unlikely to cause elution of alkali. The use of the E glass is thus preferred because, when a conductive resin product is obtained by mixing the metal-coated glass fiber with a resin material, it is possible to reduce the influence of elution from the glass fiber on the resin material.

2. Manufacturing Method of Metal-Coated Glass Fiber 1 and Metal-Coated Glass Fiber Strand 11

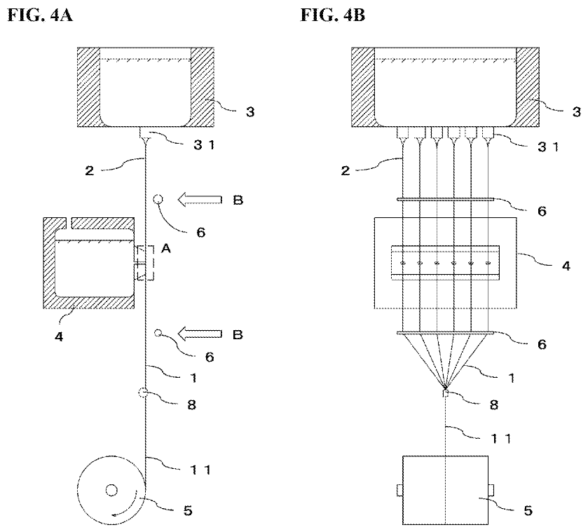

FIG. 4 is a schematic view showing one example of a device for manufacturing the metal-coated glass fiber strand 11 according to the present invention, in which FIG. 4(a) is a side view; and FIG. 4(b) is a front view of FIG. 4(a).

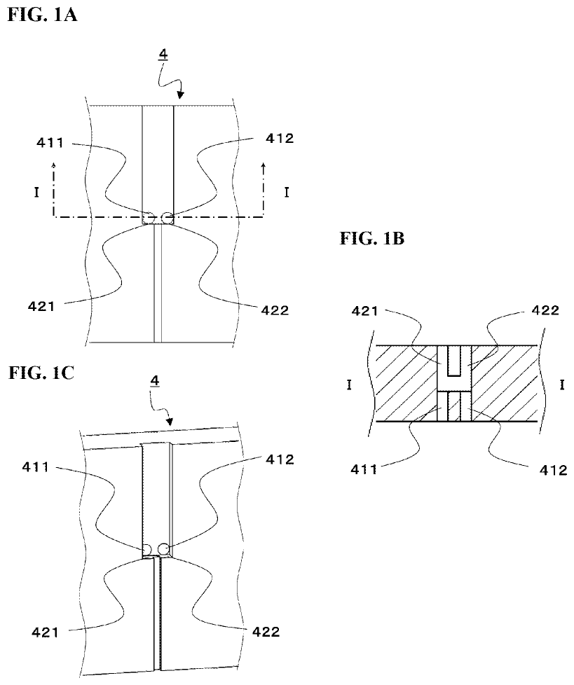

FIG. 1 is an enlarged view of region A of FIG. 4, showing a first embodiment of the present invention, in which FIG. 1(a) is a front view; FIG. 1(b) is a cross-sectional view as taken along line I-I of the front view; and FIG. 1(c) is a perspective view.

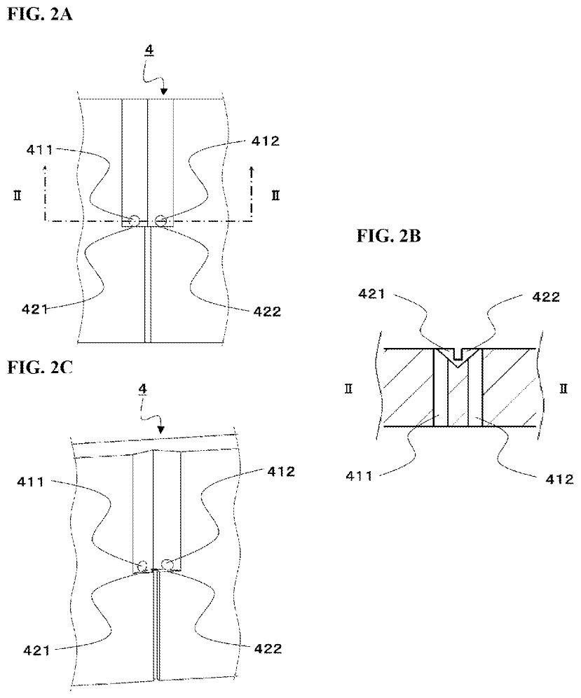

FIG. 2 is an enlarged view of region A of FIG. 4, showing a second embodiment of the present invention, in which FIG. 2(a) is a front view; FIG. 2(b) is a cross-sectional view as taken along line II-II of the front view; and FIG. 2(c) is a perspective view.

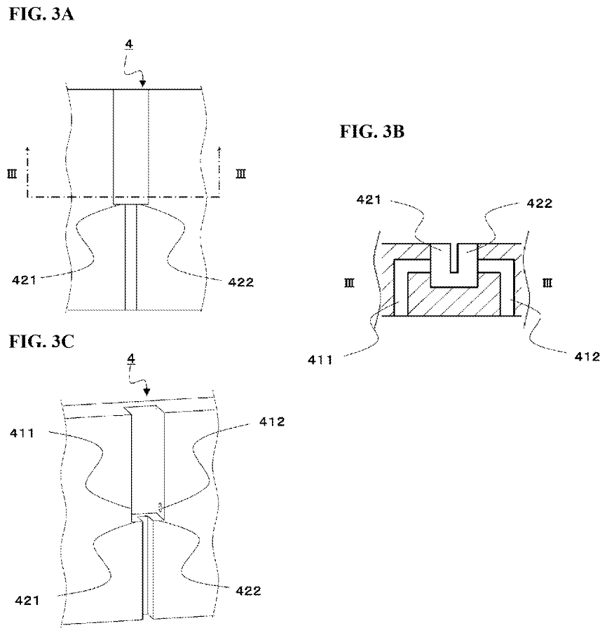

FIG. 3 is an enlarged view of region A of FIG. 4, showing a third embodiment of the present invention, in which FIG. 3(a) is a front view; FIG. 3(b) is a cross-sectional view as taken along line of the front view; and FIG. 3(c) is a perspective view.

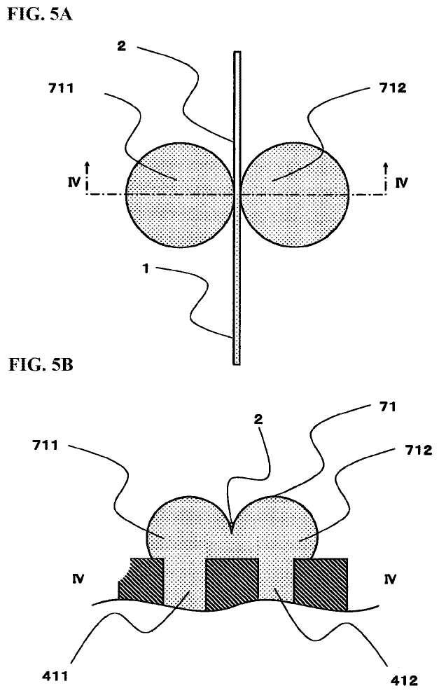

FIG. 5 is an enlarged view of region A of FIG. 4, schematically showing the state of contact of the glass fiber with droplets of the molten metal in the first embodiment, in which FIG. 5(a) is a front view; and FIG. 5(b) is a cross-sectional view as taken along line IV-IV of the front view.

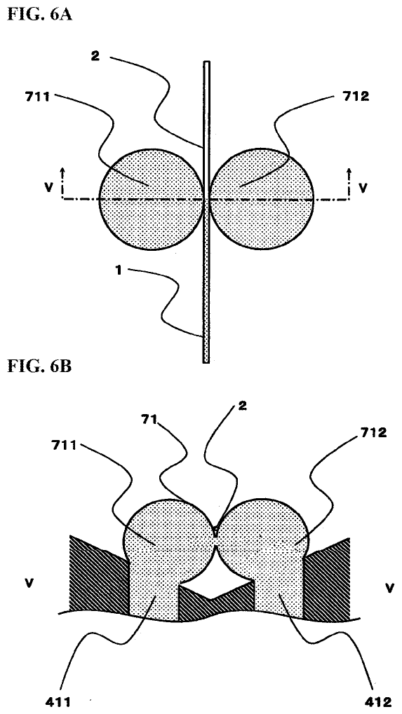

FIG. 6 is an enlarged view of region A of FIG. 4, schematically showing the state of contact of the glass fiber with droplets of the molten metal in the second embodiment, in which FIG. 6(a) is a front view; and FIG. 6(b) is a cross-sectional view as taken along line V-V of the front view.

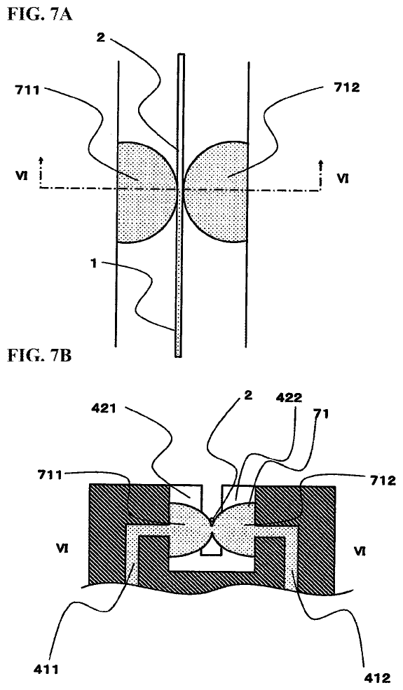

FIG. 7 is an enlarged view of region A of FIG. 4, schematically showing the state of contact of the glass fiber with droplets of the molten metal in the third embodiment, in which FIG. 7(a) is a front view; and FIG. 7(b) is a cross-sectional view as taken along line VI-VI of the front view.

The glass fiber 2 is drawn from a bushing nozzle 31 which is disposed on a lower part of a glass melting furnace 3. The molten metal is applied to the glass fiber 2. After that, one piece of the metal-coated glass fiber or a strand of two or more pieces of the metal-coated glass fiber is wound by a winding machine 5. The molten metal applied to the glass fiber 2 is discharged from a metal melting furnace 4. The metal melting furnace 4 is located between the bushing nozzle 31 and the winding machine 5 and has orifices 411 and 412 arranged, on a side thereof facing the glass fiber 2, to discharge the molten metal out therefrom. By discharge of the molten metal from the orifices 441 and 412, molten metal droplets 711 and 712 are formed.

It is preferable to use a pushing unit 6 in order to bring the glass fiber 2 into contact with the molten metal droplets 711 and 712. The pushing unit 6 is located at any position that allows contact of the glass fiber 2 with the molten metal droplets 711 and 712. In FIG. 4, for example, the pushing unit 6 is opposed to the metal melting furnace 4 with the glass fiber 2 interposed therebetween. In this case, the glass fiber 2 is pushed by the pushing unit 6 in the direction of arrows B in FIG. 4(b) and thereby brought into contact with the molten metal droplets 711 and 712 for application of the molten metal to the glass fiber 2.

In the case of producing two or more pieces of the metal-coated glass fiber 1 by drawing a plurality of pieces of the glass fiber 2 from a plurality of bushing nozzles 31, it is preferable to arrange a gathering shoe 8 between the metal melting furnace 4 and the winding machine 5. In this case, the two or more pieces of the metal-coated glass fiber 1 are passed through the gathering shoe 8 and thereby gathered together into a strand. The thus-obtained metal-coated glass fiber strand 11 is wound by the winding machine 5.

The gathering shoe 8 can be of the common type capable of gathering a predetermined number of pieces of the metal-coated glass fiber 1 to obtain a predetermined number of pieces of the metal-coated glass fiber strand 11. There is no particular limitation on the gathering shoe 8 as long as the gathering shoe 8 is formed using a heat-resistant smooth surface part. Examples of the heat-resistant smooth surface part are those of ceramic, graphite, surface-polished metal and the like. Further, the smooth surface part can suitably be in the form of a comb-shaped article, a plate- or bar-shaped article with a groove, or the like.

In addition to the gathering shoe 8, a sizing agent may be used for gathering of the metal-coated glass fiber 1. In the case of using the sizing agent, it is preferable to use a machine for feeding the sizing agent to the metal-coated glass fiber 1. Preferably, the feeding machine is arranged between the metal melting furnace 4 and the winding machine 5 so as to apply the sizing agent before or while gathering the glass fiber by the gathering shoe 8 or after gathering the glass fiber by the gathering shoe 8. There is no particular limitation on the feeding machine as long as it is capable of applying the sizing agent to the metal-coated glass fiber 1. For example, the sizing agent can be applied by passing the metal-coated glass fiber 1 or the metal-coated glass fiber strand 11 through an applicator (not shown) into which the sizing agent is fed.

<Formation of Glass Fiber 2>

The glass fiber 2 is formed by drawing the glass melt from the bushing nozzle 31 which is disposed on the lower part of the glass melting furnace 3. The bushing nozzle 31 can be made of platinum or a platinum-rhodium alloy. Preferably, the bushing nozzle 31 is formed with a nozzle diameter of about 1 to 5 mm for discharge of the glass melt. The nozzle diameter of the bushing nozzle 31 can be adjusted as appropriate depending on the desired diameter of the glass fiber 2. The number of bushing nozzles 31 can be set as appropriate. In terms of workability, the number of bushing nozzles 31 is preferably 1 to about several hundreds. The temperature of the glass melt to be fiberized varies depending on the glass composition. In the case of the E-glass composition, it is preferable to adjust the temperature of the glass melt such that the temperature of the glass melt drawing out the busing nozzle 31 is 1100 to 1350° C.

<Metal Melting Furnace 3 and Formation of Metal Coating Layer 7>

The metal coating is applied to the glass fiber 2 during the period between the time when the glass fiber is drawn through the bushing nozzle 31 and the time when the glass fiber is wound by the winding machine 5. To obtain the metal coating layer 7, the molten metal droplets 711 and 712 are first formed by preparing the molten metal in the metal melting furnace 4 and discharge the resulting molten metal from the orifices 411 and 412 which are disposed on a wall surface of the metal melting furnace 4. The molten metal discharged from the orifice 411, 412 can be easily formed into a dome-shaped molten metal droplet 711, 712 when the orifice 411, 412 and surroundings thereof are low in wettability with the molten metal. Then, the glass fiber 2 is brought into contact with the molten metal droplets 711 and 712 whereby the metal coating layer 7 is formed on the glass fiber 2. When the dome-shaped molten metal droplets 711 and 712 are not formed in this metal coating step, the molten metal would flow away without remaining on and around the orifices 411 and 412. It is thus preferable that the orifice 411, 412 and surroundings thereof are low in wettability with the molten metal.

In order for the orifice 411, 412 and surroundings thereof to be low in wettability with the molten metal, it is preferable that the orifice is made of a ceramic material. Examples of the ceramic material usable are alumina, zirconia, silicon carbide, boron nitride, silicon nitride, aluminum nitride and the like. The orifice 411, 412 can be formed in various shapes such as circular shape, oval shape, rectangular shape, square shape, trapezoidal shape and the like.

Preferably, the orifice 411, 412 has an opening area of 0.75 to 80 mm². When the orifice opening area is smaller than 0.75 mm², it becomes difficult to discharge the molten metal from the orifice. When the orifice opening area is larger than 80 mm², the molten metal may be discharged too much and flow away without remaining on and around the orifice 411, 412. In view of these, the orifice opening area is more preferably in the range of 3 to 60 mm².

It is preferable that the dome-shaped molten metal droplets 711 and 712 come into contact with a plurality of points of the glass fiber 2. For example, the area at which the molten metal droplets 711 and 712 abut or overlap each other is assumed as a recess point in the composite molten metal droplet 71 as shown in FIGS. 5, 6 and 7. The glass fiber 2 is drawn through the recess point and brought into contact with both of the molten metal droplets 711 and 712.

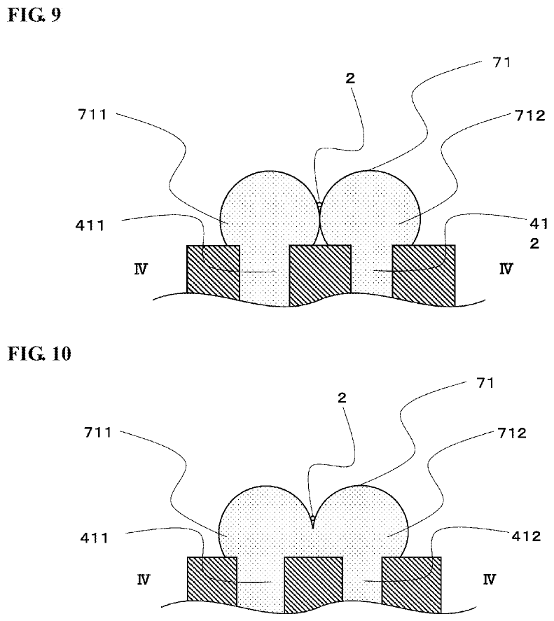

Herein, the expression “the molten metal droplets abut each other” means the state where the surfaces of the two molten metal droplets contact each other at one point without allowing the flow of the molten metal between the molten metal droplets (see FIG. 9).

The expression “the molten metal droplets overlap each other” means the state where the contours of the surfaces of the two molten metal droplets intersect to provide an overlap between the molten metal droplets while allowing the flow of molten metal between the molten metal droplets (see FIG. 10). A surface of the molten metal is oxidized in an oxygen-containing atmosphere, thereby forming a metal oxide film. Since the metal oxide film performs the function of the droplet interface even at the area where the molten metal droplets 711 and 712 contact each other, these two molten metal droplets 711 and 712 would not be easily combined into a simple droplet shape. The molten metal droplets 711 and 712 partially overlap each other so that the recess is defined in the composite molten metal droplet. In the case of the molten metal being of zinc or zinc alloy, it is easy to define the recess in the composite molten metal droplet because the zinc or zinc alloy is easily meltable at a temperature lower than or equal to the softening point of the glass (e.g. the softening point of the E glass being 840° C.) due to the fact that the melting point of zinc melt is 420° C.

By forming the molten metal droplets 711 and 712 such that the molten metal droplets abut or partially overlap each other, it is possible to perform hot-dipping treatment on the glass fiber 2 without shifting the path of the glass fiber so that the glass fiber 2 is stably brought into contact with the molten metal droplets 711 and 712. The molten metal droplet 711, 712 on the orifice 411, 412, whose material is low in wettability with the molten metal, receives a force in a direction that causes contraction of the molten metal droplet 711, 712 by the action of a capillary force that contracts the molten metal droplet 711, 712 toward the orifice 411, 412 and a surface tension exerted on the molten metal droplet 711, 712. When the hot-dipping treatment is initiated by bringing the glass fiber 2 into contact with those droplets 711 and 712, the metal amount of the droplets 711 and 712 becomes decreased. The molten metal droplets 711 and 712 slightly contract with decrease in metal amount. If the molten metal droplets 711 and 712 do not abut or partially overlap each other, the path of the glass fiber 2 may be shifted in either contraction direction or bent randomly due to the contraction of the molten metal droplets 711 and 712. When the molten metal droplets 711 and 712 contact each other, the contraction forces of the molten metal droplets 711 and 712 are balanced at such a contact recess point. The hot-dipping treatment is thus performed, without shifting the path of the glass fiber 2, so as to ensure the stable contact of the glass fiber 2 and the molten metal droplets 711 and 712. The distance between the centers of the orifices 411 and 412 can be set as appropriate such that the molten metal droplets 711 and 712 discharged from the respective orifices 411 and 412 are contactable with the glass fiber 2. It is preferable that the distance between the centers of the orifices 411 and 412 is in the range of 0.1 to 5.0 mm.

The opening angle of the two orifices 411 and 412 is determined as an angle formed mutually by base surfaces of the molten metal droplets 711 and 712 on the orifices 411 and 412 and by base surfaces of parts defining orifices (hereinafter referred to as “orifice base surfaces”). In the case where the opening angle formed mutually by the orifices 411 and 412 and by the orifice base surfaces is 180°, the orifices are opened at the same base surface as shown in FIG. 1(c). In the case where the opening angle formed mutually by the orifices 411 and 412 and by the orifice base surfaces are opened at different base surfaces as shown in FIG. 2(c). The smaller the opening angle of the two orifices 411 and 412, the easier the molten metal droplets 711 and 712 contact each other even when small in diameter. This can result in strong contact of the molten metal droplets 711 and 712 so that the composite molten metal droplet 71 has a simple droplet shape with no recess point. It is thus not preferable that the opening angle of the two orifices 411 and 412 is set too small. The opening angle of the two orifices 411 and 412 is preferably in the range of 30 to 180° for easy definition of the recess point in the composite molten metal droplet 71. The two orifices 411 and 412 may be arranged and opposed to each other in a direction perpendicular to the passage direction of the glass fiber 2 as shown in FIG. 3(c).

In order to stably maintain the dome-shaped molten metal droplet 711, 712 on the orifice 411, 412 with the base surfaces of the molten metal droplet 711, 712 arranged in the vertical direction along the path of the glass fiber 2, it is preferable to support lower portions of the molten metal droplets 711 and 712 by horizontal parts 421 and 422. The glass fiber 2, when drawn at a high speed, generates an airflow in the vicinity of the glass melting furnace 4. If this airflow is not stable, the molten metal droplets 711 and 712 may be deformed in shape under the influence of the airflow. The state of contact between the glass fiber 2 and the molten metal droplet 711, 712 changes due to the deformation of the molten metal droplet 711, 712. The deformation of the molten metal droplet 711, 712 is not preferable in terms of the uniform thickness of the metal coating layer. The deformation of the molten metal droplet 711, 712 is preferably suppressed by supporting the lower portions of the molten metal droplets 711 and 712 by the horizontal parts 412 and 422.

As in the case of the orifices 411 and 412, it is preferable that the horizontal parts 421 and 422 provided below the respective orifices are made of a material low in wettability with the molten metal. A ceramic material is preferred as such a low-wettability material. Examples of the ceramic material usable are alumina, zirconia, silicon carbide, boron nitride, silicon nitride, aluminum nitride and the like. The horizontal parts 421 and 422 may be provided by cutting grooves on the orifices, or may be attached to the orifices 411 and 412. The length of protrusion of the horizontal part 421, 422 from the orifice 411, 412 is preferably in the range of 0.1 to 6.0 mm. When the protrusion length is 0.1 mm or larger, it is easy to stably maintain the shape of the molten metal droplet 711, 712. When the protrusion length exceeds 6.0 mm, on the other hand, the amount of the molten metal required for the hot-dipping treatment of the glass fiber 2 with the molten metal droplets 711 and 712 becomes increased so that the molten metal may flow away without remaining on the orifices 411 and 412 and the horizontal parts 421 and 422. In view of these, the protrusion length of the horizontal part 421, 422 is more preferably in the range of 0.2 to 5.0 mm. In the present invention where the metal application is performed by sandwiching the glass fiber 2 between the molten metal droplets 711 and 712, it is feasible to provide the parts 421 and 422 so as to ensure space for the path of the glass fiber and not to interfere with the path of the glass fiber. More specifically, the parts 421 and 422 can be provided, with the space that does not interfere with the path of the glass fiber 2, by setting the width of the groove on the lower side of the orifices 411 and 422 larger than that on the upper side of the orifices 411 and 422. In order to allow the grooves to ensure the space for the path of the glass fiber 2 in the hot-dipping treatment, the width of the groove on the lower side of the orifices 411 and 412 is preferably 0.1 to 2.5 mm. When the width of the groove is smaller than 0.1 mm, the glass fiber 2 may be broken by contact with the orifice 411, 412 due to vibrations of the glass fiber 2 during the passage. The occurrence of such fiber breakage leads to a deterioration of productivity during the manufacturing process. When the width of the groove is larger than 2.5 mm, the molten metal tends to be pulled by the glass fiber 2 into the groove so that there is obtained the metal-coated glass fiber 1 in which the metal coating layer 7 is undesirably nonuniform. For these reasons, the width of the groove on the lower side of the orifices 411 and 412 is more preferably 0.1 to 2.0 mm, still more preferably 0.1 to 1.5 mm.

The amount of the molten metal fed from the orifice 411, 412 can be adjusted as appropriate depending on the shape of the orifice 411, 412, the distance between the orifice 411, 412 and the liquid surface of the molten metal in the metal melting furnace 4, the viscosity of the molten metal, and the like. The larger the distance between the orifice 411, 412 and the liquid surface of the molten metal in the metal melting furnace 4, the larger the amount of the molten metal fed. The smaller the distance between the orifice 411, 412 and the liquid surface of the molten metal in the metal melting furnace 4, the smaller the amount of the molten metal fed. Since the viscosity of the molten metal largely varies depending on the kind and composition of the metal used etc., it is preferable to adjust the viscosity of the molten metal as appropriate.

The material of the outer wall surface of the metal melting furnace 4, with which the molten metal droplets 711 and 711 come into contact, can be appropriately selected from ceramic, metal, glass, carbon and the like. In the case of using a ceramic material, alumina, zirconia, silicon carbide, boron nitride, silicon nitride, aluminum nitride and the like are suitably usable.

The metal melting furnace 4 can be appropriately heated with a heater etc. The inside temperature of the metal melting furnace 4 needs to be set higher than the melting point of the metal to be molten. Further, the adhesion of the glass fiber 2 and the metal coating layer 7 tends to increase with increase in the heating temperature of the metal melting furnace 4 (reason 1). When the heating temperature of the metal melting furnace 4 is set too high, however, sludge is likely to occur at the upper surface of the molten metal depending on the metal composition so that the productivity of the metal-coated glass fiber strand 11 may be deteriorated (reason 2). In addition, the metal melting furnace 4 requires a heat-resistant part and thus becomes expensive (reason 3). For these reasons, it is not preferable to set the heating temperature of the metal melting furnace 4 too high. In view of the above reasons 1 to 3, the temperature of the metal melting furnace 4 is preferably in the range of 400 to 1000° C. in the case where the molten metal in the furnace contains zinc alloy. Since it is not preferable that the temperature of the metal melting furnace 4 is too high for the reasons 2 and 3, the upper limit of the temperature of the metal melting furnace 4 may preferably be set to 850° C., more preferably 750° C., still more preferably 600° C., yet more preferably 550° C. When the temperature of the metal melting furnace 4 is low, it may take time to melt the metal. For this reason, the lower limit of the temperature of the metal melting furnace 4 may be set to 450° C. In the case of using high-melting-point metal such as aluminum (melting point: 660° C.) or titanium (melting point: 1668° C.) or an alloy containing at least one such high-melting-point metal, the melting point or freezing point of the metal or alloy may be out of the above temperature range. In this case, the heating temperature of the metal melting furnace 4 can be changed as appropriate so as to be higher than or equal to the melting point or freezing point of the metal or alloy.

In the case where the molten metal contains aluminum, titanium or the like, a passive film is formed on the upper surface of the molten metal. With the formation of such a passive film, sludge is unlikely to occur at the upper surface of the molten metal even when the temperature of the metal melting furnace 4 is raised. It thus becomes easy to produce the metal-coated glass fiber strand 11. From this point of view, it is preferable that the metal coating layer 7 contains at least one selected from the group consisting of aluminum and titanium.

<Application of Metal Coating to Glass Fiber 2>

The glass fiber 2 runs and passes by the metal melting furnace 4 by being wound by the winding machine 5. The metal coating layer 7 is formed on the glass fiber 2 by pressing the glass fiber 2 into contact with the molten metal droplets 711 and 712 discharged from the metal melting furnace 4. For movement of the glass fiber 2 relative to the first and second molten metal droplets, the pushing unit 6 may be shifted so as to force the glass fiber 2 toward the metal melting furnace 4 (i.e. in the direction of arrows B in FIG. 4(b)) and thereby press the glass fiber 2 into contact with the molten metal droplets 711 and 712. Alternatively, the metal melting furnace 4 may be shifted toward the glass fiber 2 so as to press the glass fiber 2 into contact with the molten metal droplets 711 and 712.

The amount of the molten metal required per unit time for the formation of the metal coating layer 7 on the glass fiber 2 varies depending on the diameter (R: μm) of the glass fiber, the thickness (t: μm) of the metal coating layer 7, the winding speed (s: m/min) of the winding machine and the gravity (p: g/cm³) of the metal for coating. Hence, the amount of the molten metal (M: g/min) fed from the orifices 411 and 412 is estimated by the following equation (III).

M=(R×t×π×s×p)×10⁻⁶ (III)

In the case of producing the glass fiber with a zinc coating of 1.0 μm thickness under the conditions of a fiber diameter of 28 μm and a winding speed of 290 m/min, for example, the ideal feed amount of the molten metal is determined to be 0.18 g/min according to the equation (III).

The speed at which the glass fiber 2 passes by the metal melting furnace 4 can be adjusted according to the winding speed of the winding machine 5. This speed is preferably in the range of 100 to 5000 m/min. Since the winding speed also has an influence on the diameter of the glass fiber 2, the winding speed is determined from the viewpoint of shape design of the metal-coated glass fiber 1. When the winding speed is lower than 100 m/min, the fiber diameter becomes larger than 60 μm. There occurs a high incidence of fiber breakage when the winding speed is higher than 5000 m/min. The occurrence of such fiber breakage leads to a deterioration of productivity during the manufacturing process.

In the case of using the pushing unit 6, the pushing unit 6 is initially located apart from the glass fiber 2 and equipped with a moving mechanism. The pushing unit 6 is moved by the movement mechanism to adjust the passage position of the glass fiber 2 such that the glass fiber 2 is brought into contact with the dome-shaped molten metal droplets 711 and 712 on the orifices 411 and 412. There is no particular limitation on the pushing unit 6 as long as the pushing unit 6 is capable of controlling the passage position of the glass fiber 2, is equipped with any stably operable moving mechanism and is formed using a heat-resistant smooth surface part.

As the moving mechanism of the pushing unit 6, there can be used a stage having a fine adjustment system with two or more axes, a robot having a moving system with two or more axes, or the like. Examples of the heat-resistant smooth surface part are those of ceramic, graphite, surface-polished metal and the like. The heat-resistant smooth surface part functions as a guide to allow passage of the glass fiber 2 at the initiation of drawing of the glass fiber 2 and maintain the constant positional relationship of the glass fiber 2 with the molten metal droplets 711 and 712 on the orifices 411 and 412 during the metal coating, and thus can suitably be in the form of an article with a hole, a comb-shaped article, a plate- or bar-shaped article with a groove, or the like.

In the case of the article with the hole, the hole may be formed into a circular shape, oval shape, rectangular shape, square shape, trapezoidal shape or the like. A part of the peripheral edge of the hole may be cut as a groove. Preferably, the opening area of the article with the hole is in the range of 0.2 to 20 mm². When the opening area is smaller than 0.2 mm², it becomes difficult to pass the glass fiber 2 through the hole at the initiation of drawing of the glass fiber 2. When the opening area is larger than 20 mm², on the other hand, the passage position of the glass fiber 2 tends to change so that it becomes difficult to maintain the constant positional relationship of the glass fiber 2 with the molten metal droplets 711 and 712. In view of these, the opening area of the article with the hole is more preferably in the range of 0.8 to 7 mm².

In the case of the comb-shaped article, the length of teeth of the comb-shaped article is preferably in the range of 0.1 to 100 mm. When the length of the teeth is smaller than 0.1 mm, it becomes difficult to guide the path of the glass fiber 2 by the teeth. When the length of the teeth is larger than 100 mm, the teeth becomes easy to break. In view of these, the length of teeth of the comb-shaped article is more preferably in the range of 1 to 100 mm. With the use of the comb-shaped article as the pushing unit 6, it becomes easy to guide the paths of two or more pieces of the glass fiber 2.

The pushing unit 6 may be provided not only on the lower side of the metal melting furnace 4 but also on the upper side of the metal melting furnace 4. The pushing unit may be provided on either one or both of the upper and lower sides of the metal melting furnace 4. It is preferable that the pushing unit is provided on both of the upper and lower sides of the metal melting furnace 4 because the glass fiber 2 can be precisely pressed into contact with the molten metal droplets 711 and 712.

### First Embodiment (FIGS. 1 and 5)

The formation of the metal coating layer 7 according to the first embodiment will be explained below with reference to FIGS. 1 and 5.

In the first embodiment, the two orifices 411 and 412 are arranged side by side on the side surface of the metal melting furnace 4 so as to discharge therefrom the droplets 711 and 712 of the molten metal; and the horizontal parts 421 and 422 are arranged below the respective orifices. In order to obtain this configuration, two grooves of different cross-sectional dimensions are vertically adjacently formed in the side surface of the metal melting furnace 4 such that the horizontal parts 421 and 422 are constituted by a step between these two grooves in FIG. 1.

The two molten metal droplets 711 and 712 are discharged from the respective orifices such that the end portions of the molten metal droplets abut or overlap each other. The glass fiber 2 is passed downward through the recess point between the two molten metal droplets and brought into contact with both of the two molten metal droplets, whereby the glass fiber 2 is coated with the metal (see FIG. 5).

### Second Embodiment (FIGS. 2 and 6)

In the second embodiment, the two orifices 411 and 412 are arranged horizontally side by side as in the first embodiment. Further, the horizontal parts 421 and 422 are arranged below the respective orifices. However, the two orifices are arranged such that the base surfaces of the two molten metal droplets on the respective orifices form an angle smaller than 180° in the second embodiment (see FIGS. 2 and 6). The two molten metal droplets 711 and 712 are discharged through the respective orifices such that the end portions of the molten metal droplets abut or overlap each other. The glass fiber 2 is passed downward through the recess point between the two molten metal droplets and brought into contact with both of the two molten metal droplets, whereby the glass fiber 2 is coated with the metal (see FIG. 6).

### Third Embodiment (FIGS. 3 and 7)

In the third embodiment, the two orifices 411 and 412 are opposed to each other so as to allow abutting or overlapping of the two molten metal droplets. The two molten metal droplets 711 and 712 are discharged through the respective orifices such that the end portions of the molten metal droplets abut or overlap each other. The glass fiber 2 is passed downward through the recess point between the two molten metal droplets and brought into contact with both of the two molten metal droplets, whereby the glass fiber 2 is coated with the metal (see FIG. 7).

<Fiber Sizing>

In the present invention, it is preferable to draw one to several hundred pieces of the glass fiber 2 from the bushing nozzle 31, apply the metal coating to the respective glass fiber, and then, gather two to several hundred pieces of the metal-coated glass fiber 1 together as the metal-coated glass fiber strand by the gathering shoe 8. In other words, the manufacturing method of the metal-coated glass fiber strand 11 utilizes the above-mentioned manufacturing method of the metal-coated glass fiber 1 and includes the step of producing the metal-coated glass fiber strand 11 by gathering two or more pieces of the glass fiber 2 coated with the molten metal. Hereinafter, the production of the metal-coated glass fiber strand 11 will be explained below.

The metal-coated glass fiber strand 11 is produced by paralleling two or more pieces of the metal-coated glass fiber 1 and gathering the paralleled pieces of the metal-coated glass fiber 1 together into a strand. It is feasible to gather two or more pieces of the metal-coated glass fiber 1 together before the winding of the metal-coated glass fiber 1 by the winding machine 5. Alternatively, two or more pieces of the metal-coated glass fiber 1 may be paralleled and gathered together after the winding of the metal-coated glass fiber 1 by the winding machine 5. In another alternative, several hundreds to about 200000 pieces of the metal-coated glass fiber may be paralleled and gathered together into one by bundling two or more pieces of the metal-coated glass fiber strand 11. The number of pieces of the metal-coated glass fiber can be set as appropriate depending on the purpose and method of use of the metal-coated glass fiber strand 11. In the case of using the metal-coated glass fiber strand as a roving for SMC (sheet molding compound), for example, the metal-coated glass fiber strand is generally produced by gathering about 10000 to 20000 pieces of the metal-coated glass fiber. In the case of processing the metal-coated glass fiber strand by cutting into a chopped strand, it is preferable to gather about 10 to 10000 pieces of the metal-coated glass fiber.

The metal-coated glass fiber strand 11 is favorably produced by controlling the thickness unevenness (V: %) of the metal coating layer 7 to 100% or less during the production of the metal-coated glass fiber strand 11. When the thickness unevenness (V: %) of the metal coating layer 7 is more than 100%, the metal-coated glass fiber strand 11 becomes easier to shrink or fluff.

The metal-coated glass fiber 1 can be gathered by wrapping a resin sheet etc. around pieces of the glass fiber, or by strongly integrating pieces of the glass fiber with the sizing agent. It is preferable that the pieces of the glass fiber are strongly integrated with the sizing agent because, when the thus-obtained glass fiber strand is cut, fluffing of the glass fiber strand is suppressed. It is particularly preferable to use the sizing agent in liquid form for good productivity in mass-production. In other words, the production of the metal-coated glass fiber strand preferably includes the step of applying the sizing agent to the metal coating layer 7. In this case, the application of the sizing agent to the metal-coated glass fiber 1 and the gathering of the metal-coated glass fiber 1 can be done simultaneously or sequentially one after another. The sizing agent may be applied by, after the gathering of the glass fiber, immersing the glass fiber strand in the sizing agent.

There is no particular limitation on the method for application of the sizing agent. In ordinary glass fiber drawing operation, a sizing agent is applied to a glass fiber with the use of an applicator in which two or more pieces of the glass fiber are immersable in the sizing agent; and, after the application of the sizing agent, the two or more pieces of the glass fiber are gathered into one strand by passing through a fiber guide called a gathering shoe. In the dwawing of the metal-coated glass fiber 1, the application of the sizing agent and the gathering of the metal-coated glass fiber can be done by similar mechanisms. The application of the sizing agent to the metal-coated glass fiber is not necessarily performed by the applicator. Alternatively, the sizing agent may be applied to the metal-coated glass fiber 1 by arranging two or more pieces of the wound metal-coated glass fiber in parallel and then immersing these pieces of the wound metal-coated glass fiber in the sizing agent. In another alternative, the sizing agent may be applied to the metal coating layer 7 of the metal-coated glass fiber 1 by spraying or by any application machine such as roller.

The metal-coated glass fiber 1 or metal-coated glass fiber strand 11 to which the sizing agent has been applied is subjected to drying by volatilizing a volatile component such as dispersion medium contained in the sizing agent. The drying can be done by air-drying or by heating with a thermostat or hot air. When the heating temperature is too high or when the heating time is too long, oxidation of the surface of the metal coating layer 7 may proceed to affect the conductivity of the metal coating layer. In view of these, it is preferable that the metal-coated glass fiber strand 11 to which the sizing agent has been applied is dried under the conditions of a drying temperature of 40 to 250° C. and a drying time of 10 minutes to 8 hours.

(Sizing Agent)

The sizing agent is in the form of an emulsion containing a resinous dispersoid and a dispersion medium. The concentration of the dispersoid in the sizing agent is preferably 2 to 15 wt %. When the concentration of the dispersoid in the sizing agent is lower than 2 wt %, the gathering of the glass fibers tends to be insufficient. When the concentration of the dispersoid in the sizing agent is higher than 15 wt %, the sizing agent tends to be redundant so that the surplus of the sizing agent removed before the drying may be increased. The concentration of the dispersoid in the sizing agent may be more preferably 2 to 10 wt %.

Further, the pH of the sizing agent is in the range of 5 to 10. When the pH of the sizing agent is lower than 5, the sizing agent is strongly acid and thus may cause damage to the surface of the metal coating layer 7. When the pH of the sizing agent is higher than 10, the sizing agent is strongly alkaline and thus, when the glass fiber strand is processed into a chopped strand or fibrous filler and kneaded into a various resin material in the later steps, may cause decomposition of the resin material.

As the resinous dispersoid, there can be used at least one kind selected from the group consisting of epoxy resin, polyurethane resin, polyamide resin, phenol resin and polyester resin. The use of such a resinous dispersoid allows two or more pieces of the metal-coated glass fiber 1 to be strongly gathered together. Even when the metal-coated glass fiber strand 11 is dried after the application of the sizing agent, the dispersoid remains inside the metal-coated glass fiber strand 11 or on the surface of the metal-coated glass fiber strand 11. It is thus said that the metal-coated glass fiber strand 11 obtained using the sizing agent may contain at least one kind selected from the group consisting of epoxy resin, polyurethane resin, polyamide resin, phenol resin and polyester resin.

As the dispersion medium, there can be used water, an organic solvent or a mixture thereof. Examples of the organic solvent usable are: lower alcohol solvents such as ethyl alcohol and isopropyl alcohol; ketone solvents such as methyl ethyl ketone and methyl isobutyl ketone; glycol ether solvents such as ethylene glycol monomethyl ether, propylene glycol monoethyl ether, ethylene glycol monomethyl ether acetate and propylene glycol monoethyl ether acetate; nitrogen-containing solvents such as dimethylformamide, dimethylacetamide and N-methylpyrrolidone; ester solvents such as ethyl acetate and butyl acetate; hydrocarbon solvents such as hexane, toluene, benzene and xylene; ether solvents such as diethyl ether and diisopropyl ether; and any mixture thereof.

Since water has no flammability, the use of water as the main dispersion medium eliminates the need for explosion-proof equipment. Further, the use of the organic solvent as the main dispersion medium leads to an improvement in conductivity by suppression of surface oxidation of the metal coating layer 7. In the case of using water as the main dispersion medium, it may become easy to emulsify the above dispersoid with the addition of a small amount of the organic solvent.

The sizing agent may contain, in addition to the above components, a surfactant, a silane coupling agent, a pH adjuster and the like. As the surfactant, there can be used a known surfactant such as anionic surfactant, cationic surfactant, amphoteric surfactant, nonionic surfactant or the like. It is often the case that the surfactant, even when used in a small amount, exerts a sufficient effect. Thus, the surfactant is preferably contained in an amount of e.g. 0.0001 to 10 wt %.

As the silane coupling agent, there can be a known silane coupling agent. Examples of the silane coupling agent are 3-glycidyloxypropyltrimethoxysilane, 3-glycidyloxypropyltriethoxysilane, 5,6-epoxyhexyltriethoxysilane, 5,6-epoxyhexyltriethoxysilane, 2-(3,4-epoxycyclohexyl)ethyltrimethoxysilane, 2-(3,4-epoxycyclohexyl)ethyltriethoxysilane, 3-oxetanylpropyltriethoxysilane, 3-aminopropyltrimethoxysilane, 3-aminopropyltriethoxysilane,3-mercaptopropyltrimethoxysilane, 3-mercaptopropyltriethoxysilane, methyltrimethoxysilane, methyltriethoxysilane, methyltripropoxysilane, methyltriisopropoxysilane, ethyltrimethoxysilane, ethyltriethoxysilane, ethyltripropoxysilane, ethyltriisopropoxysilane, propyltrimethoxysilane, propyltriethoxysilane, propyltripropoxysilane, propyltriisopropoxysilane and the like.

As the pH adjuster, there can be used a known acid or alkali. Examples of the pH adjuster are inorganic acids such as hydrochloric acid, sulfuric acid and nitric acid, acetic acid, trifluoroacetic acid, methanesulfonic acid, phthalic acid, succinic acid, sodium hydroxide, calcium hydroxide, potassium hydroxide, ammonia, choline and the like.

(Use of Metal-Coated Glass Fiber Strand 11)

The metal-coated glass fiber strand 11 can be combined (mixed) with a resin material to form a conductive resin product. Thus, the metal-coated glass fiber strand 11 is processed in various forms for easy combination with the resin material. For example, the metal-coated glass fiber strand 11 can be processed by cutting into a chopped strand. The metal-coated fiber strand 11 can be used as a continuous fiber strand without cutting.

As a cutting method of the metal-coated glass fiber strand 11, there can be used a known method of cutting the glass fiber 1 with a cutter or the like. The metal-coated glass fiber strand 11 may be processed into a chopped strand by using a direct chopper in place of the winding machine 5 and performing the cutting on-line during the drawing. The length of the chopped strand is set to e.g. 1 to 100 mm. A particulate of the metal-coated glass fiber strand 11 may be obtained by pulverization of the chopped strand.

As the resin material combined with the glass fiber strand, there can be used a known resin material. Examples of the resin material are: thermoplastic resins such as low-density polyethylene, high-density polyethylene, polypropylene, polyvinyl chloride, polystyrene, polyvinyl acetate, methacrylic resin, ABS resin, metallocene resin, polyamide, polyacetal, polycarbonate, polyphenylene ether, polyethylene terephthalate, polybutylene terephthalate, liquid crystal polymer, polyphenylene sulfide, polyimide, polyether sulfone, polyether ether ketone and fluorocarbon polymer; thermosetting resins such as epoxy resin, silicone resin, phenol resin, unsaturated polyester resin and polyurethane; rubbers; elastomers; and the like. For viscosity control, a thickening agent such as cellulose, glucose or gelatin, an organic solvent such as acetone, methyl ethyl ketone, methyl isobutyl ketone, ethanol, isopropyl alcohol, normal propyl alcohol, butanol, ethyl acetate, butyl acetate, xylene or toluene, or water may be added to the resin material. The amount of the metal-coated glass fiber strand 11 in the conductive resin product may be e.g. 0.01 to 30 vol %.

The thus-obtained conductive resin product is applicable as an electrically conductive resin substance for various uses. For example, an adhesive obtained by combination of the glass fiber strand with thermosetting resin material and moisture-curable resin material is applicable as a conductive adhesive alternative to soldering. The conductive resin product is also applicable, as a part or casing for a vehicle or electronic equipment where electromagnetic-shielding performance is required, so as to shield electromagnetic waves and thereby prevent interference or malfunction of the vehicle or electronic equipment due to electromagnetic noise and the influence of the electromagnetic waves on the health.

### EXAMPLES

The present invention will be described in more detail below by way of the following examples and comparative examples. It should however be understood that the present invention is not limited to the following examples. Metal-coated glass fibers obtained in the following examples were evaluated by the following test methods.

(1) Measurement of Diameter of Glass Fiber, Rate of Metal Coating Layer on Entire Fiber Circumference of Glass Fiber and Thickness of Metal Coating Layer, and Determination of Average Thickness of Metal Coating Layer

A metal-coated glass fiber strand was fixed in a cold embedding resin (available as EpoFix from Marumoto Struers K.K.). The resin was cut so that a cross section of the metal-coated glass fiber strand was viewed. The cross section was polished with a waterproof abrasive paper No. 8000. The polished cross section was observed with a CCD microscope (available as VHX-500 from Keyence Corporation). From the observed fiber cross section image, 30 pieces of metal-coated glass fiber were selected. As for each selected piece of glass fiber, the diameter of the glass fiber, the rate of the metal coating layer on the entire circumference of the glass fiber and thickness of the metal coating layer were measured. The average thickness and thickness unevenness of the metal coating layer of the metal-coated glass fiber were determined based on these measurement results. More specifically, the average thickness T (μm) of the metal coating layer of the metal-coated glass fiber was determined from the maximum thickness Tmax (μm) of the metal coating layer and the minimum thickness Tmin (μm) of the metal coating layer by the following equation: T=(Tmax+Tmin)/2. Further, the thickness unevenness V of the metal coating layer of the metal-coated glass fiber was determined by the following equation: V (%)={(Tmax−Tmin)/T}×100.

(2) Check of Shrinkage of Metal-Coated Glass Fiber Strand

As a metal-coated glass fiber strand sizing agent, a treatment liquid was prepared by adjusting an urethane resin emulsion (available as Yodosol RC32 from Henkel Japan Ltd.) to a solid matter concentration of 2.7 mass %. A metal-coated glass fiber strand with 3000 pieces of glass fiber was immersed in the treatment liquid for 10 seconds. After that, a surplus of the treatment liquid was removed from the glass fiber strand. The glass fiber strand was then dried. After the drying, the appearance of the glass fiber strand was examined to check the occurrence or non-occurrence of shrinkage of the glass fiber strand.

### Example 1

A glass material of E-glass composition was melted at 1250° C. in the glass melting furnace and drawn as a fiber from the nozzle of the glass melting furnace. The resulting glass fiber was passed through a V-shaped groove of the pushing unit, which was made of graphite, and then, wound by the winding machine. The winding speed of the winding machine was adjusted such that the drawing speed at which the glass fiber passed by the metal melting furnace became 1000 m/min. To form a metal coating layer of an alloy with a zinc content of 99.5 mass % and a titanium content of 0.5 mass %, a metal mixture of pure zinc (purity 99.9%) with 0.5 mass % of pure titanium (purity 99.9%) was provided as a raw material and melted in the metal melting furnace. The melting temperature of the metal melting furnace was set to 650° C. The metal feed rate of the metal melting furnace was set to 0.6 g/min.

On the side surface of the metal melting furnace, two orifices were arranged. Further, horizontal parts were arranged below the respective orifices by forming grooves of different dimensions on upper and lower sides of the orifices as shown in FIG. 1. The opening area of the respective two orifices was set to 1.0 mm². The distance between the centers of the horizontally arranged orifices was set to 1.7 mm. The angle formed mutually by the orifices and the orifice base surfaces was set to 180°. Herein, the orifice base surface corresponds to the base surface of the molten metal liquid on the orifice. The width and depth of the groove on the upper side of the orifices were set to 2.2 mm and 1.8 mm, respectively. The width and depth of the groove on the lower side of the orifices were set to 0.5 mm and 0.8 mm, respectively.

After the winding of the glass fiber by the winding machine was initiated, the pushing unit of graphite was shifted in the direction of arrows B in FIG. 4 by means of an XY stage so as to bring the path of the glass fiber into contact with the recess point between first and second droplets of the molten metal fed from the orifices. With this, the metal-coated glass fiber was obtained.

The above evaluation tests (1) and (2) were performed on the obtained metal-coated glass fiber to evaluate the metal coating form and gathering property of the glass fiber strand. The fiber diameter of the metal-coated glass fiber was 11 μm. The coverage of the metal coating layer on the circumference of the glass fiber was 100%. The metal coating layer of the glass fiber has an average thickness of 2.2 μm and a thickness unevenness of 23%. It was confirmed that the metal coating layer was uniformly formed on the glass fiber. The glass fiber strand in which a predetermined number of pieces of the glass fiber were gathered using the sizing agent showed no shrinkage and thus was suitable for use as a metal-coated glass fiber filler.

### Example 2

As shown in FIG. 1, horizontal parts were arranged below the respective orifices on the side surface of the metal melting furnace by forming grooves of different cross-sectional dimensions on the upper and lower sides of the orifices. The opening area of the respective orifices was set to 1.5 mm². The distance between the centers of the horizontally arranged orifices was set to 2.2 mm. The width and depth of the groove on the upper side of the orifices were set to 2.8 mm and 2.0 mm, respectively. The width and depth of the groove on the lower side of the orifices were set to 0.7 mm and 1.8 mm, respectively. The metal-coated glass fiber was obtained by the same method as in Example 1, except for the above settings. The above evaluation tests (1) and (2) were performed on the obtained metal-coated glass fiber to evaluate the metal coating form and gathering property of the glass fiber strand. The fiber diameter of the metal-coated glass fiber was 11 μm. The coverage of the metal coating layer on the circumference of the glass fiber was 100%. The metal coating layer of the glass fiber has an average thickness of 2.4 μm and a thickness unevenness of 21%. It was confirmed that the metal coating layer was uniformly formed on the glass fiber. The glass fiber strand in which a predetermined number of pieces of the glass fiber were gathered using the sizing agent showed no shrinkage and thus was suitable for use as a metal-coated glass fiber filler.

### Example 3

The metal-coated glass fiber was obtained by the same method as in Example 1, except that: the depth of the groove on the lower side of the orifices the orifices was set to 1.8 mm; and the protrusion length of the horizontal parts below the orifices was set to 0 mm. The above evaluation tests (1) and (2) were performed on the obtained metal-coated glass fiber to evaluate the metal coating form and gathering property of the glass fiber strand. The fiber diameter of the metal-coated glass fiber was 11 μm. The coverage of the metal coating layer on the circumference of the glass fiber was 100%. The metal coating layer of the glass fiber has an average thickness of 9.2 μm and a thickness unevenness of 100%. It was confirmed that the metal coating layer was uniformly formed on the glass fiber. The glass fiber strand in which a predetermined number of pieces of the glass fiber were gathered using the sizing agent showed no shrinkage and thus was suitable for use as a metal-coated glass fiber filler.

### Example 4

As shown in FIG. 1, horizontal parts were arranged below the respective orifices on the side surface of the metal melting furnace by forming grooves of different cross-sectional dimensions on the upper and lower sides of the orifices. One of the grooves had a isosceles triangular cross section with a vertex angle of 120°. The orifices for discharge of the molten metal were respectively arranged on oblique sides of the isosceles triangular cross-section groove so that the angle formed mutually by the orifices and the orifice base surfaces was set to 120°. The metal-coated glass fiber was obtained by the same method as in Example 1, except for the above orifice configuration. The above evaluation tests (1) and (2) were performed on the obtained metal-coated glass fiber to evaluate the metal coating form and gathering property of the glass fiber strand. The fiber diameter of the metal-coated glass fiber was 11 μm. The coverage of the metal coating layer on the circumference of the glass fiber was 100%. The metal coating layer of the glass fiber has an average thickness of 2.8 μm and a thickness unevenness of 18%. It was confirmed that the metal coating layer was uniformly formed on the glass fiber. The glass fiber strand in which a predetermined number of pieces of the glass fiber were gathered using the sizing agent showed no shrinkage and thus was suitable for use as a metal-coated glass fiber filler.

### Comparative Example 1

A glass material of E-glass composition was melted at 1250° C. in the glass melting furnace and drawn as a fiber from the nozzle of the glass melting furnace. The resulting glass fiber was passed through a V-shaped groove of the pushing unit, which was made of graphite, and then, wound by the winding machine. The winding speed of the winding machine was adjusted such that the drawing speed at which the glass fiber passed by the metal melting furnace became 1000 m/min. To form a metal coating layer of an alloy with a zinc content of 99.5 mass % and a titanium content of 0.5 mass %, a metal mixture of pure zinc (purity 99.9%) with 0.5 mass % of pure titanium (purity 99.9%) was provided as a raw material and melted in the metal melting furnace. The melting temperature of the metal melting furnace was set to 650° C. The metal feed rate of the metal melting furnace was set to 0.6 g/min.

For application of the metal coating to the glass fiber, one orifice was provided to discharge therefrom a droplet of the molten metal. The opening area of the orifice was set to 1.0 mm². Further, a horizontal part was provided below the orifice by forming grooves of the same shape as in Example 1. The protrusion length of the orifice was set to 1 mm. The metal-coated glass fiber was obtained by bringing the glass fiber into contact with the droplet of the molten metal on the orifice from one direction.

The above evaluation tests (1) and (2) were performed on the obtained metal-coated glass fiber to evaluate the metal coating form and gathering property of the glass fiber strand. The fiber diameter of the metal-coated glass fiber was 11 μm. The coverage of the metal coating layer on the circumference of the glass fiber was 40%. The glass fiber was partially not covered with the metal coating. The metal coating layer of the glass fiber has an average thickness of 3.0 μm and a thickness unevenness of 200%. It was confirmed that the metal coating layer was nonuniform. The glass fiber strand in which a predetermined number of pieces of the glass fiber were gathered using the sizing agent showed shrinkage and thus was difficult to use as a metal-coated glass fiber filler.

TABLE 1

| | Ex. 1 | Ex. 2 | Ex. 3 | Ex. 4 | Com. Ex. 1 |
|---|---|---|---|---|---|
| Opening Area (mm²) of Orifice | 1 | 1.5 | 1 | 1 | 1 |
| Distance (mm) between | 1.7 | 2.2 | 1.7 | 1.7 | — |
| Centers of Orifices | | | | | |
| Angle (°) between | 180 | 180 | 180 | 120 | — |
| Orifice Base Surfaces | | | | | |
| Protrusion Length (mm) of | 1 | 0.2 | 0 | 1 | 1 |
| Horizontal Part below Orifice | | | | | |
| Composition of | 0.5Ti—Zn | 0.5Ti—Zn | 0.5Ti—Zn | 0.5Ti—Zn | 0.5Ti—Zn |
| Metal Coating Layer | | | | | |
| Metal Coverage Rate (%) | 100 | 100 | 100 | 100 | 40 |
| Average Thickness (μm) of | 2.2 | 2.4 | 9.2 | 2.8 | 3.0 |
| Metal Coating Layer | | | | | |
| Thickness Unevenness (%) of | 23 | 21 | 100 | 18 | 200 |
| Metal Coating Layer | | | | | |
| Shrinkage of Metal-Coated | Not | Not | Not | Not | Occurred |
| Glass Fiber Strand | Occurred | Occurred | Occurred | Occurred | |

(Effect of Uniform Metal Coating on Glass Fiber)

As is clear from the results of Examples 1 to 4, each of which falls within the scope of the present invention, the thickness unevenness of the metal coating layer was controlled to be 100% or less by passing the glass fiber through the recess point in the composite molten metal droplet and bringing the glass fiber into contact with both of the two first and second molten metal droplets. With such thickness unevenness, the metal coating was shrinked isotopically in the cross section of the glass fiber, whereby there occurred no shrinkage of the metal-coated glass fiber strand.

In Comparative Example 1, on the other hand, the application of the metal coating was performed from one direction. As a result, the metal coating layer became nonuniform in thickness in the circumferential direction of the glass fiber.

(3) Production of Chopped Strands from Metal-Coated Glass Fiber Strand

### Examples 5 to 8

First, 3000 pieces of the metal-coated glass fibers obtained in Example 1 were paralleled and gathered together into a strand. The thus-formed metal-coated glass fiber strand was immersed in a sizing agent. After a surplus of the sizing agent was removed from the metal-coated glass fiber strand, the metal-coated glass fiber strand was dried by being placed in a thermostat of 80° C. for 60 minutes.

The sizing agent used was prepared by mixing a polyurethane resin emulsion (available as Yodosol RC32 from Henkel Japan Ltd.) as a raw material for a resinous dispersoid and water or 2-propanol (iPA) as a dispersion medium such that the concentration of the polyurethane resin in the sizing agent was set to a value as shown in TABLE 2. In each Example, the pH of the sizing agent was set to 7.

Then, the metal-coated glass fiber strand was cut by a cutter into chopped strands of 6 mm length. The obtained chopped strands were tested by the following evaluation test methods (A) and (B). The evaluation test results are shown in TABLE 2.

(A) Appearance of Chopped Strands

The appearance of the chopped strands was visually inspected and evaluated in the following three grades.

1: Gathered into a strand and good in appearance without fluffing.
2: Gathered into a strand, but slightly fluffed.
3: Not gathered into a strand, or apparently defective in appearance.

(B) Evaluation of Sizing Agent

The influence of the sizing agent on the conductivity of the metal-coated glass fiber was examined as follows. First, 10 g of the chopped strands were immersed in 100 ml of dimethylformamide for 1 minute. After that, the chopped strands were washed twice with 100 ml of dimethylformamide to remove the sizing agent adhered thereon. The thus-obtained chopped strands were utilized as a test sample.

Then, 200 mm³ of the test sample was weighted and put into a cylindrical container made of insulating material with a diameter of 17 mm and a height of 4 mm so that the cylindrical container was filled with the test sample. The electrical resistance of the test sample was measured with a tester by inserting electrodes of the tester into the test sample at an interval of 17 mm.

The metal-coated glass fiber strand before the application of the sizing agent was also cut into a length of 6 mm. The electrical resistance of this sample was measured in the same manner as above and found to be 1Ω or lower in each example. It is thus considered that, when the electrical resistance of the test sample was 10Ω or lower, the sizing agent was suitable without influence on the conductivity of the metal-coated glass fiber.

TABLE 2

| | Sizing Agent | | | | Evaluation Test Results | |
|---|---|---|---|---|---|---|
| | Composition | | | | | (B) |
| | | Kind of | Amount of | | (A) | Electrical |
| | Amount of | Disper- | dispersion | | Appearance | Resistance |
| | Resin/ | sion | medium/ | | of Chopped | of Test |
| | wt % | Medium | wt % | pH | Strands | Sample/Ω |
| Ex. 5 | 3 | water | 97 | 7 | 1: good | <1 |
| Ex. 6 | 5 | water | 95 | 7 | 1: good | <1 |
| Ex. 7 | 5 | iPA | 95 | 7 | 1: good | <1 |
| Ex. 8 | 1 | water | 99 | 7 | 2: fluffing | — |

As shown in TABLE 2, the chopped strands of Examples 5 to 7 had good appearance; and the test samples of Examples 5 to 7 had an electrical resistance lower than 1Ω. The chopped strands of Example 8 maintained its strand form, but had a slightly fluffed appearance. It has been shown by these results that the metal-coated glass fiber strand according to the present invention is suitably usable as a chopped strand and is also suitably usable as a conductive resin product by combination with a resin material. The electrical resistance of the test sample of Example 8 was not measured and thus indicated as “-” in TABLE 2.

### DESCRIPTION OF REFERENCE NUMERALS

1: Metal-coated glass fiber
11: Metal-coated glass fiber strand
2: Glass fiber
21: Non-Metal-Coated Surface
3: Glass Melting Furnace
31: Bushing Nozzle
4: Metal Melting Furnace
411, 412: Orifice for Discharge of Molten metal
421, 422: Horizontal Part below Orifice
5: Winding Machine
6: Pushing Unit
7: Metal Coating Layer
71: Composite Molten metal Droplet
711, 712: Molten metal Droplet
8: Gathering shoe

1. A manufacturing method of a metal-coated glass fiber, comprising:
drawing a glass fiber from a bushing nozzle of a glass melting furnace;
discharging, from an orifice of a metal melting furnace in which a metal for forming a metal coating layer is molten, a molten metal in a dome shape or substantially spherical shape; and
bringing the glass fiber into contact with the molten metal,
wherein the metal melting furnace has on a wall surface thereof two orifices to discharge two droplets of the molten metal such that end portions of the two droplets abut or overlap each other to define a recess therebetween, and
wherein the metal coating layer is formed on the glass fiber by passing the glass fiber downward through the recess and bringing the glass fiber into contact with both of the two droplets.

2. The manufacturing method of the metal-coated glass fiber according to claim 1, wherein surfaces of the two orifices are made of a ceramic material.

3. The manufacturing method of the metal-coated glass fiber according to claim 1, wherein the two orifices are arranged side by side on the wall surface of the metal melting furnace such that an angle formed by base surfaces of the two droplets of the molten metal on the two orifices ranges from 30 to 180°.

4. The manufacturing method of the metal-coated glass fiber according to claim 1, wherein the two orifices are opposed to each other.

5. The manufacturing method of the metal-coated glass fiber according to claim 1, further comprising: adjusting an amount of the molten metal discharged from the orifices in accordance with at least one of a shape of the orifices, a distance between the orifices and a liquid surface of the molten metal in the metal melting furnace and a viscosity of the molten metal.

6. The manufacturing method of the metal-coated glass fiber according to claim 1, wherein horizontal parts are respectively provided below the two orifices.

7. The manufacturing method of the metal-coated glass fiber according to claim 6, wherein surfaces of the horizontal parts are made of a ceramic material.

8. A metal-coated glass fiber, comprising:
a glass fiber; and
a metal coating layer formed on an entire circumference of the glass fiber,
wherein the metal coating layer satisfies the following conditions: T=(Tmax+Tmin)/2, V={(Tmax−Tmin)/T}×100, 0.2 μm≤T≤10 μm and V≤100% where Tmax (μm) is a maximum thickness of the metal coating layer; Tmin (μm) is a minimum thickness of the metal coating layer; and T (μm) is an average thickness of the metal coating layer; and V (%) is a thickness unevenness of the metal coating layer.

9. The metal-coated glass fiber according to claim 8, wherein the metal coating layer contains at least one selected from the group consisting of zinc, aluminum, tin, indium and titanium.

10. A manufacturing method of a metal-coated glass fiber strand, comprising:
providing two or more pieces of the glass fiber coated with the molten metal by the manufacturing method of the metal-coated glass fiber according to claim 1; and
producing the metal-coated glass fiber strand by gathering the two or more pieces of the glass fiber coated with the molten metal.

11. The manufacturing method of the metal-coated glass fiber strand according to claim 10, wherein the producing the metal-coated glass fiber strand includes applying a sizing agent to the metal coated on the glass fiber.

12. The manufacturing method of the metal-coated glass fiber strand according to claim 11, wherein the sizing agent is an emulsion containing a resinous dispersoid and a dispersion medium, and wherein the concentration of the dispersoid in the sizing agent is 2 to 15 wt %.

13. A metal-coated glass fiber strand comprising two or more pieces of the metal-coated glass fiber according claim 8 being gathered together along a length direction thereof.

14. The metal-coated glass fiber strand according to claim 13, comprising at least one kind selected from the group consisting of epoxy resin, polyurethane resin, polyamide resin, phenol resin and polyester resin.
